(19) United States
(12) Patent Application Publication
(10) Pub. No.: US 2012/0058234 A1
(43) Pub. Date: Mar. 8, 2012

(54) FOLDABLE COOKER

(76) Inventor: Yftach Navon, Petah Tikva (IL)

(21) Appl. No.: 13/319,880

(22) PCT Filed: Dec. 8, 2009
(86) PCT No.: PCT/IL09/01160

§ 371 Date: Nov. 10, 2011

Related U.S. Application Data
(60) Provisional application No. 61/223,041, filed on Jul. 5, 2009.

(51) Int. Cl. F24C 1/00; H05B 3/68; A23L 1/01; H05B 6/10

(52) U.S. Cl. 426/523; 126/38; 219/647; 219/452.13; 219/453.13

(57) ABSTRACT

A device for food preparation. The device comprises: (a) a vertical support; (b) at least one arm characterized by a longitudinal axis. The arm is pivotally connected to the vertical support; (c) at least one cooker connected to of the arms, such that the plane of the at least one cooker is substantially parallel to the longitudinal axis of the arm. The device is characterized by two positions: (i) a FOLDED position; and, (ii) a horizontally OPERATIVE position; in the FOLDED position, the longitudinal axis of the arm is substantially parallel to the vertical support, and in the OPERATIVE position, the longitudinal axis of the arm is substantially perpendicular to the vertical support. The device is adapted to save space when the device is in the FOLDED position.

### FIELD OF THE INVENTION

The present invention generally relates to a device for a preparation, and more specifically, to a foldable cooker.

### BACKGROUND OF THE INVENTION

From one side, the increase in the real estate prices worldwide results in the necessity of a more efficient utilization of its actual space.

From the other side, there is a trend to reduce the size of domestic and office mechanization facilities, such as radios, copy machines, food processors, etc.

Another trend in the search for more economic space utilization is using modular devices of normal sizes that are simply put one on top of the other. The best example for this is with washing machines, dryers and dishwashers which are assembled one on top of the other with the bottom one standing on the floor.

An additional trend is designing flat wall mounted appliance that gradually replace the regular equipment of similar purpose that is usually standing on the floor or on the table. For example: there are no more long-case clocks, they were replaced by wall clocks; Massive television sets that usually stood on the floor or on the table are being replaced by flat wall-mounted ones; Flat computer screens are replacing the large ones; Computer and television screens are combined into new universal devices.

The kitchen is one of the places where steps of space saving have to be taken to make the utility area more efficient.

Known in the art cookers usually occupy a significant space in the kitchen. In modern kitchens the trend is to look for ways to modernize the cookers in order to save space while maintaining their quality.

This modernization of cookers is for example the following: gas cookers are replaced with electrical and induction cookers; compact cookers are developed, these cookers can be easily removed and stored after utilization; and, burners are integrated in the kitchen table.

The kitchen and more specifically the kitchen table usually require a space which is usually “wasted” for the cookers. Therefore there is a long felt need to develop a new type of a compact cooker for a preparation of food. This cooker has to able to fold when not in used, an unfold when needed.

### SUMMARY OF THE INVENTION

It is one object of the present invention to provide a device for food preparation. The device comprises:
a. a vertical support.
b. at least one arm characterized by a longitudinal axis. The at least one arm is pivotally connected to the vertical support.
c. at least one cooker connected to the at least one arm, such that the plane of the at least one cooker is substantially parallel to the longitudinal axis of the at least one arm.

It is within the scope of the present invention that the device is characterized by two positions: (i) a FOLDED position; and, (ii) a horizontally OPERATIVE position. in the FOLDED position, the longitudinal axis of the at least one arm is substantially parallel to the vertical support, and in the OPERATIVE position, the longitudinal axis of the at least one arm is substantially perpendicular to the vertical support. It is also within the scope of the present invention that the device is adapted to save space when the device is in the FOLDED position.

It is another object of the present invention to provide the device as defined above, wherein the at least one cooker is selected from a group consisting of: a gas cooker, an electrical cooker, an electro-magnetic cooker, an induction cooker, an oil cooker, a solid fuel cooker, or any combination thereof.

It is another object of the present invention to provide the device as defined above, wherein the device is mountable to a wall by means of the vertical support.

It is another object of the present invention to provide the device as defined above, wherein the device further comprises an activation mechanism which is adapted to convert the device from the FOLDED position into the OPERATIVE position, and/or vice versa.

It is another object of the present invention to provide the device as defined above, wherein the activation mechanism is electronically activated by means of a switch.

It is another object of the present invention to provide the device as defined above, wherein the device is adapted to be installed above a surface selected from a group consisting of: a table, a kitchen table, the kitchen working surface, the lower kitchen closet, the marble of the kitchen, or any combination thereof.

It is another object of the present invention to provide the device as defined above, wherein in OPERATIVE position, the at least one arm is in a lying position on the surface.

It is another object of the present invention to provide the device as defined above, wherein the vertical support at least partially comprises the mechanism of the at least one cooker.

It is another object of the present invention to provide the device as defined above, wherein the device is characterized by an ability to hold a predetermined weight of a cooking container placed on the at least one cooker.

It is another object of the present invention to provide the device as defined above, wherein the device further comprises a gas supply with a gas valve adapted to be connected to the at least one cooker.

It is another object of the present invention to provide the device as defined above, wherein the device further comprises an electricity power supply for connecting the device to an electricity power source.

It is another object of the present invention to provide the device as defined above, wherein the at least one arm is telescopic.

It is another object of the present invention to provide the device as defined above, wherein cooker is connected to the arm through a plate, such that the cooker is placed on the plate, and the plate is connected to the arm.

It is another object of the present invention to provide a method for using a device for food preparation. The method comprises steps of:
a. Providing a device for food preparation. The device comprises: (i) A vertical support. (ii) At least one arm characterized by a longitudinal axis. The at least one arm is pivotally connected to the vertical support. (iii) At least one cooker connected to the at least one arm, such that the plane of the at least one cooker is substantially parallel to the longitudinal axis of the at least one arm. The device is characterized by two positions: (i) a FOLDED position; and, (ii) a horizontally OPERATIVE position. In the FOLDED position, the longitudinal axis of the at least one arm is substantially parallel to the vertical support, and in the OPERATIVE position, the longitudinal axis of the at least one arm is substantially perpendicular to the vertical support.
b. Converting the device into the OPERATIVE position by pulling and lowering the at least one cooker from the vertical support to the direction of the user of the device, and thereby causing the at least one cooker to be substantially perpendicular to the vertical support.
c. converting the device into the FOLDED position by pushing and lifting the at least one cooker from the direction of the user of the device to the direction of the vertical support, and thereby causing the at least one arm to be substantially parallel to the vertical support.

It is within the scope of the present invention that the step of converting the device into the FOLDED position adapted to cause the device to save space.

It is another object of the present invention to provide a method as described above, which further comprises a step of selecting the at least one cooker from a group consisting of: a gas cooker, an electrical cooker, an electro-magnetic cooker, an induction cooker, an oil cooker, a solid fuel cooker, or any combination thereof.

It is another object of the present invention to provide the device as defined above, which further comprises a step of mounting the device to a wall by means of the vertical support.

It is another object of the present invention to provide the device as defined above, wherein at least one of the steps of converting the device into the OPERATIVE position and converting the device into the FOLDED position are performed via an activation mechanism.

It is another object of the present invention to provide the device as defined above, which further comprises a step of selecting a surface above which selected device is installed from a group consisting of: a table, a kitchen table, the kitchen working surface, the lower kitchen closet, the marble of the kitchen, or any combination thereof.

It is another object of the present invention to provide the device as defined above, which further comprises a step of lying the at least one arm on the surface.

It is another object of the present invention to provide the device as defined above, which further comprises a step of placing a cooking container on the at least one cooker.

It is another object of the present invention to provide the device as defined above, which further comprises a step of activating the at least one cooker, and thereby cooking the food contained in the cooking container.

It is another object of the present invention to provide the device as defined above, which further comprises a step of holding a predetermined weight of the cooking container placed on the at least one cooker.

It is another object of the present invention to provide the device as defined above, which further comprises a step of elongating the length of the at least one arm, wherein the at least one arm is telescopic.

It is another object of the present invention to provide the device, as defined above, which further comprises a step of placing the cooker on a plate and connecting the plate to the arm.

It is another object of the present invention to provide a device for food preparation. The device comprises:
a. a vertical support.
b. at least one plate with a plate plane. The at least one plate is pivotally connected to the vertical support.
c. at least one cooker seated upon the at least one plate, such that the plane of the at least one cooker is substantially parallel to the plane of the at least one plate.

It is within the scope of the present invention that the device being characterized by two positions: (i) a FOLDED position; and, (ii) a horizontally OPERATIVE position. In the FOLDED position, the plane of the at least one plate is substantially parallel to the vertical support, and in the OPERATIVE position, the plane of the at least one plate is substantially perpendicular to the vertical support. It is also within the scope of the present invention, that the device is adapted to save space when the device is in the FOLDED position.

It is another object of the present invention to provide a device as described above, wherein the at least one cooker is selected from a group consisting of: a gas cooker, an electrical cooker, an electro-magnetic cooker, an induction cooker, an oil cooker, a solid fuel cooker, or any combination thereof.

It is another object of the present invention to provide a device as described above, wherein the device is mountable to a wall by means of the vertical support.

It is another object of the present invention to provide a device as described above, wherein the device further comprises an activation mechanism adapted to convert the device from the FOLDED position into the OPERATIVE position, and/or vice versa.

It is another object of the present invention to provide a device as described above, wherein the activation mechanism is electronically activated by means of a switch.

It is another object of the present invention to provide a device as described above, wherein the device is adapted to be installed above a surface selected from a group consisting of: a table, a kitchen table, the kitchen working surface, the lower kitchen closet, the marble of the kitchen, or any combination thereof.

It is another object of the present invention to provide a device as described above, wherein in OPERATIVE position, the at least one plate is in a lying position on the surface.

It is another object of the present invention to provide a device as described above, wherein the vertical support at least partially comprises the mechanism of the at least one cooker.

It is another object of the present invention to provide a device as described above, wherein the device is characterized by an ability to hold a predetermined weight of a cooking container placed on the at least one cooker.

It is another object of the present invention to provide a device as described above, wherein the device further comprises a gas supply with a gas valve adapted to be connected to the at least one cooker.

It is another object of the present invention to provide a device as described above, wherein the device further comprises an electricity power supply for connecting the device to an electricity power source.

It is another object of the present invention to provide a device as described above, wherein the at least one arm is telescopic.

It is another object of the present invention to provide a method for using a device for food preparation. The method comprising steps of:
a. Providing a device for food preparation. The device comprises: (i) A vertical support. (ii) At least one plate with a plate plane, the at least one plate is pivotally connected to the vertical support. (iii) At least one cooker seated upon the at least one plate, such that the longitudinal axis of the at least one arm is substantially parallel to the plane of the at least one plate. The device is characterized by two positions: (i) a FOLDED position; and, (ii) a horizontally OPERATIVE position. In the FOLDED position, the plane of the at least one plate is substantially parallel to the vertical support, and in the OPERATIVE position, the plane of the at least one plate is substantially perpendicular to the vertical support. The device is adapted to save space when the device is in the FOLDED position;
b. Converting the device into the OPERATIVE position by pulling and lowering the at least one plate from the vertical support to the direction of the user of the device, and thereby causing the at least one plate to be substantially perpendicular to the vertical support.
c. Converting the device into the FOLDED position by pushing and lifting the at least one plate from the direction of the user of the device to the direction of the vertical support, and thereby causing the at least one cooker to be substantially parallel to the vertical support.

It is within the scope of the present invention that the step of converting the device into the FOLDED position adapted to cause the device to save space.

It is another object of the present invention to provide the method as defined above, which further comprises a step of selecting the at least one cooker from a group consisting of: a gas cooker, an electrical cooker, an electro-magnetic cooker, an induction cooker, an oil cooker, a solid fuel cooker, or any combination thereof.

It is another object of the present invention to provide the method as defined above, which further comprises a step of mounting the device to a wall by means of the vertical support.

It is another object of the present invention to provide the method as defined above, wherein at least one of the steps of converting the device into the OPERATIVE position and converting the device into the FOLDED position are performed via activation mechanism.

It is another object of the present invention to provide the method as defined above, further comprising a step of selecting a surface above which selected device is installed from a group consisting of: a table, a kitchen table, the kitchen working surface, the lower kitchen closet, the marble of the kitchen, or any combination thereof.

It is another object of the present invention to provide the method as defined above, which further comprises a step of lying the at least one arm on the surface.

It is another object of the present invention to provide the method as defined above, which further comprises a step of placing a cooking container on the at least one cooker.

It is another object of the present invention to provide the method as defined above, which further comprises a step of activating the at least one cooker, and thereby cooking the food contained in the cooking container.

It is another object of the present invention to provide the method as defined above, which further comprises a step of holding a predetermined weight of the cooking container placed on the at least one cooker.

It is another object of the present invention to provide the method as defined above, which further comprises a step of elongating the length of the at least one arm, wherein the at least one arm is telescopic.

### BRIEF DESCRIPTION OF THE FIGURES

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1a-c is a schematic illustration of a device for food preparation according to one embodiment of the present invention.

FIG. 2a-b is a schematic illustration of a device for food preparation according to a specific embodiment of the device in its OPERATIVE position.

FIG. 3a-b is a schematic illustration of a device for food preparation according to a specific embodiment of the device when said device is connected to a two-sided wall.

FIG. 4a-b is a schematic illustration of a device for food preparation according to a specific embodiment of the device in which an array of arms and cookers is presented.

FIG. 5 is a schematic illustration of a device for food preparation according to a specific embodiment of the device when the arm is a forked arm connected to two cookers.

FIG. 6a-b is a schematic illustration of a device for food preparation according to a specific embodiment of the device in which the cooker is places on a plate.

FIG. 7 is a front view photograph of the device for food preparation according to a specific embodiment.

FIG. 8 is a front view photograph of the device for food preparation according to a specific embodiment. In this embodiment the cookers are induction cookers.

FIG. 9 is a front view photograph of the device for food preparation according to a specific embodiment. The cookers in this figure are provided with a pot on them.

FIG. 10 is a front view photograph of the device for food preparation according to a specific embodiment. According to this embodiment, the cookers are gas cookers.

FIG. 11 is a front view photograph of the device for food preparation according to a specific embodiment. According to this embodiment, the cookers are a gas cookers with a pan on one the cookers.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides a device for food preparation. The device comprises:
a. a vertical support.
b. at least one arm characterized by a longitudinal axis. The at least one arm is pivotally connected to the vertical support.
c. at least one cooker connected to the at least one arm, such that the plane of the at least one cooker is substantially parallel to the longitudinal axis of the at least one arm.

The device is characterized by two positions: (i) a FOLDED position; and, (ii) a horizontally OPERATIVE position. in the FOLDED position, the longitudinal axis of the at least one arm is substantially parallel to the vertical support, and in the OPERATIVE position, the longitudinal axis of the at least one arm is substantially perpendicular to the vertical support. It is also within the scope of the present invention that the device is adapted to save space when the device is in the FOLDED position.

The term ‘food preparation’ refers hereinafter to any kind of using a standard domestic cooker.

The term ‘cooker’ refers hereinafter to a device in which a food is cooked, and can be for example also, a stove, an oven, a heater, a burner, etc.

The device of the present invention is a foldable cooker which can save space in the location in which it is installed (e.g., a kitchen, a room, a trailer, etc.) by being able to vertically fold up when not in use.

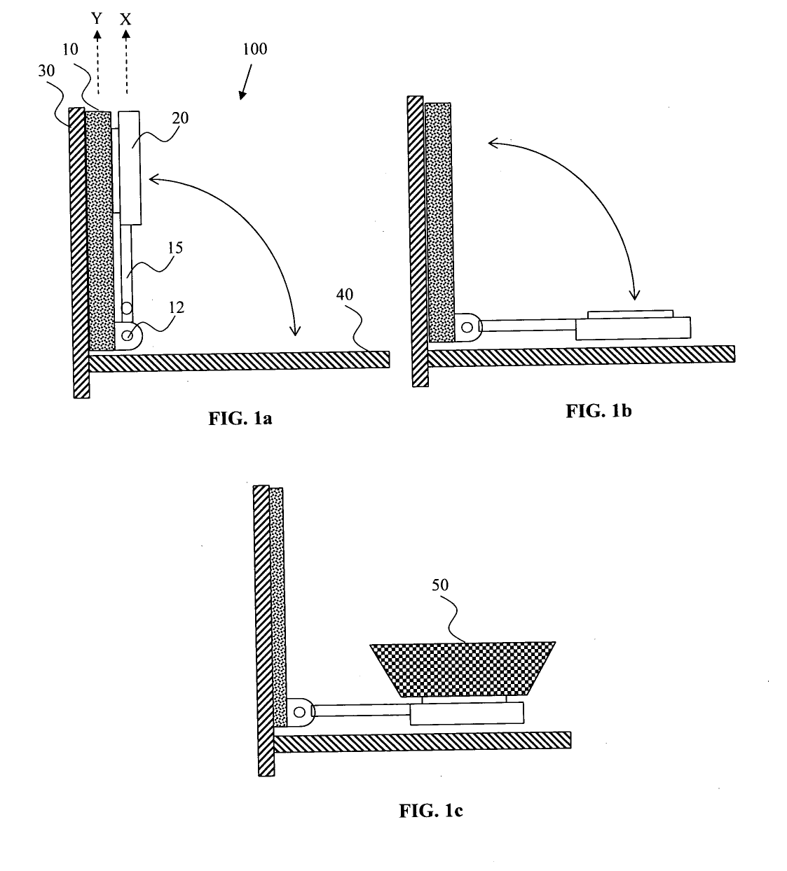

Reference is now made to FIG. 1a which schematically illustrates device 100 for food preparation according to one embodiment of the present invention. Device 100 as illustrated in this figure comprises: a vertical support 10, arm 15 and cooker 20.

According to one embodiment, arm 15 is pivotally connected to vertical support 10 via pivot 12, and cooker 20 is mechanically connected to arm 15. According to this specific embodiment, arm 15 is characterized by a longitudinal axis X, such that the plane of cooker 20 is substantially parallel to longitudinal axis X of arm 15. Moreover, vertical support 10 is characterized by plane Y.

Device 100 of the present invention is characterized by two positions: (i) a FOLDED position; and, (ii) a horizontally OPERATIVE position (illustrated in FIG. 1b and described hereinafter). FIG. 1a illustrates device 100 in its FOLDED position. In this position, the longitudinal axis X of arm 15 is substantially parallel to plane Y of vertical support 10.

According to this embodiment of the invention, device 100 is mounted to wall 30 by vertical support 10 which is mechanically interconnected to said wall.

According to this embodiment of the invention, device 100 is installed above a surface 40 which is selected from a group consisting of: a table, a kitchen table, the kitchen working surface, the lower kitchen closet, the marble of the kitchen, or any combination thereof.

Reference is now made to FIG. 1b which schematically illustrates device 100 for food preparation according to the embodiment of FIG. 1a. According to this figure, device 100 is illustrated in its OPERATIVE position. In this position, longitudinal axis X of arm 15 is substantially perpendicular to plane Y of vertical support 10. Further more, in this position—the user can use the device and cook.

As illustrated in FIG. 1a, device 100 saves space in surface 40, when the device is in its FOLDED position. This saved space of surface 40 can be for other purposes (e.g., cutting food, preparing sandwiches, etc.).

According to some embodiments of the invention, device 100 comprises an activation mechanism which is adapted to convert the device from the FOLDED position into the OPERATIVE position, and/or vice versa. This can be made, for example, switch which is electronically activated.

According to some embodiments of the invention, vertical support 10 at least partially comprises the mechanism of cooker 20. For example, vertical support 10 may comprise an electrical transformer which is responsible for the operation of cooker 20.

According different embodiments of the invention, cooker 20 is selected from a group consisting of: a gas cooker, an electrical cooker, an electro-magnetic cooker, an induction cooker, an oil cooker, a solid fuel cooker, or any combination thereof.

According to some embodiments of the invention, device 100 may comprise a gas supply with a gas valve adapted to be connected to cooker 20. According to other embodiments, device 100 may comprise an electricity power supply for connecting device 100 to an electricity power source.

According to some embodiments of the invention, arm 15 is telescopic. In this case, the length of said arm can vary according to a specific necessity. For example, when the size of surface 40 is too big, the arm 15 may be elongated to a proper and convenient size.

Reverence in now made to FIG. 1c which illustrates device 100 of the specific embodiment of FIG. 1b. According to FIG. 1c, a cooking container 50 (e.g., a pot, a pan, a skillet, a kettle, etc.) is places on cooker 20. Device 100 of the present invention is characterized by an ability to hold a predetermined weight (e.g., about 50 kg.) of cooking container 50 without breaking.

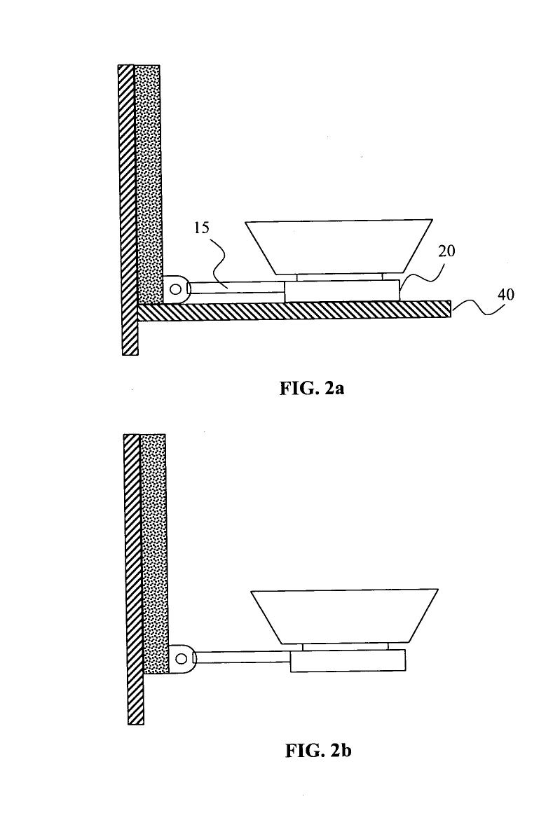

Reference is now made to FIG. 2a which illustrates a specific embodiment of device 100 in its OPERATIVE position. In this figure, cooker 20 is lying on surface 40, such that the cooker is supported by said surface. According to some embodiments, arm 15 may lie on surface 40. According other embodiments, arm 15 with cooker 20 may lie on surface 40.

Reference is now made to FIG. 2b which illustrates a specific embodiment of device 100 in its OPERATIVE position. In this figure, there is no surface under cooker 20 at all.

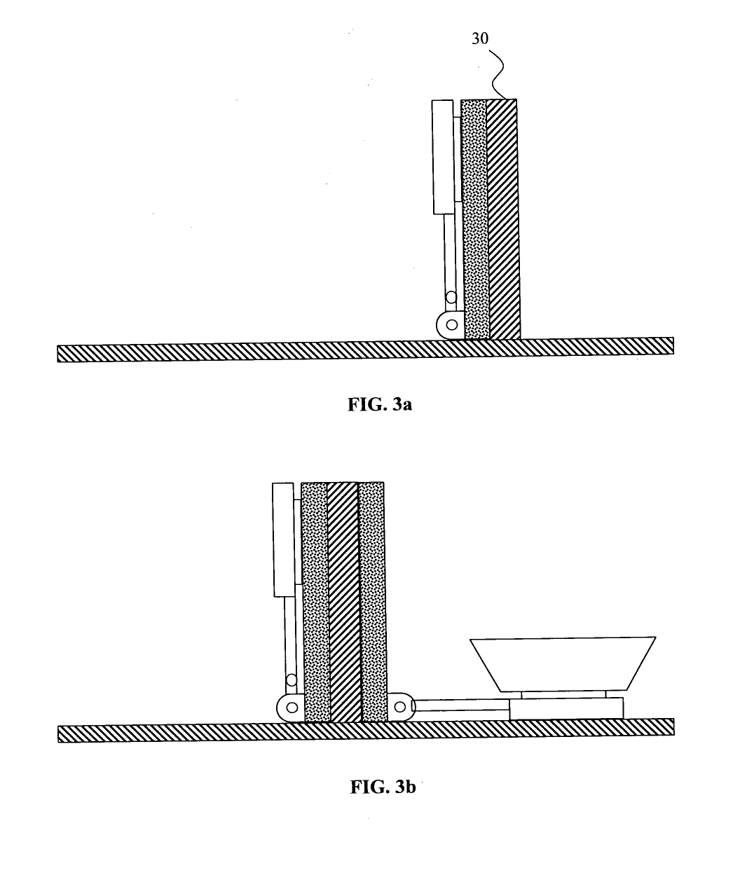

Reference is now made to FIG. 3a which illustrates a specific embodiment of device 100 in its FOLDED position. In this figure, wall 30 is a two sided wall, and device 100 is installed on one of said sides. As illustrated in FIG. 3b, device 100 might be installed in both sided of said wall.

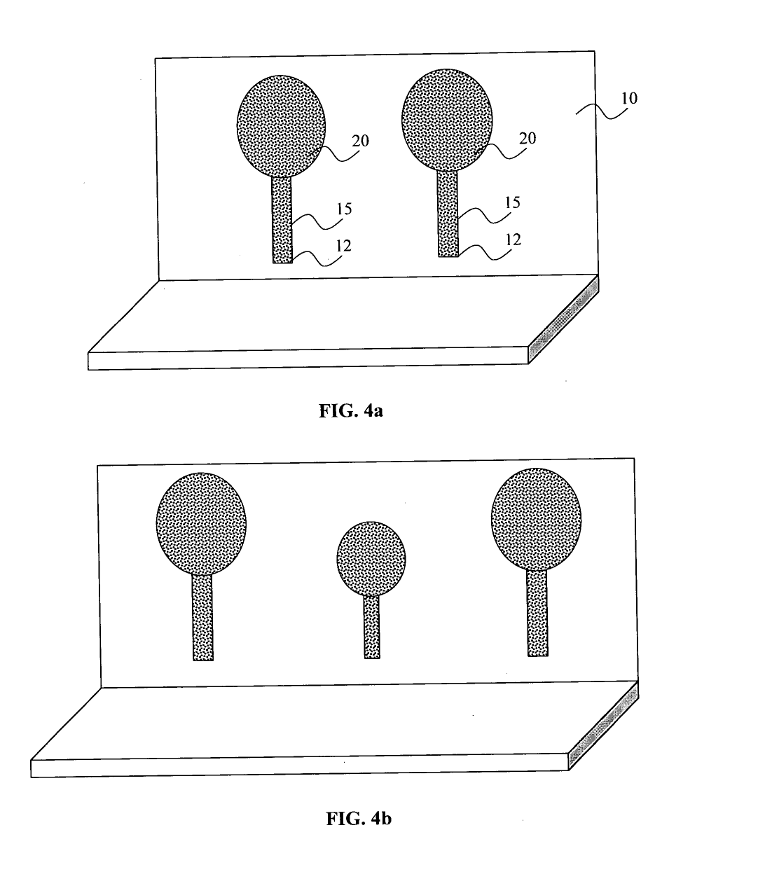

Reference is now made to FIG. 4a which schematically illustrates a preferred embodiment of device 100. According to this embodiment, a set of two arms 15 are pivotally connected to vertical support 10 via pivot 12. Each arm 15 is connected to cooker 20. According to some embodiments of the invention, cookers 20 may be of different types (e.g., one is an induction cooker and the other one is a gas cooker).

According to some embodiments, arms 15 are convertible from the FOLDED position to the OPERATIVE position (and vice versa) in a separately and independently of each other. According to other embodiments, arms 15 are convertible from the FOLDED position to the OPERATIVE position (and vice versa) together in a simultaneous manner.

Reference is now made to FIG. 4a which schematically illustrates a specific embodiment of device 100. According to this figure, an array of arms with cookers connected to each arm is illustrated. According to some embodiments, the arms and the cookers may be characterized by various sizes and types.

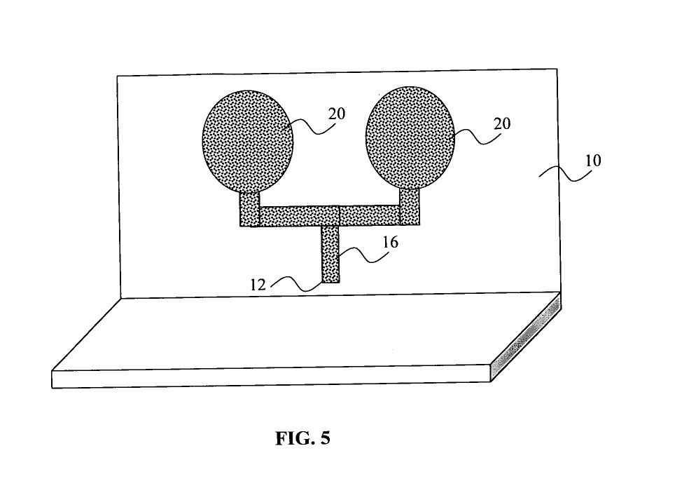

Reference is now made to FIG. 5 which schematically illustrates another embodiment of device 100. According to this embodiment, a forked arm 16 is pivotally connected to vertical support 10 via pivot 12. Forked arm 16 is connected to two cookers 20. According to some embodiments of the invention, cookers 20 may be of different types (e.g., one is an induction cooker and the other one is a gas cooker).

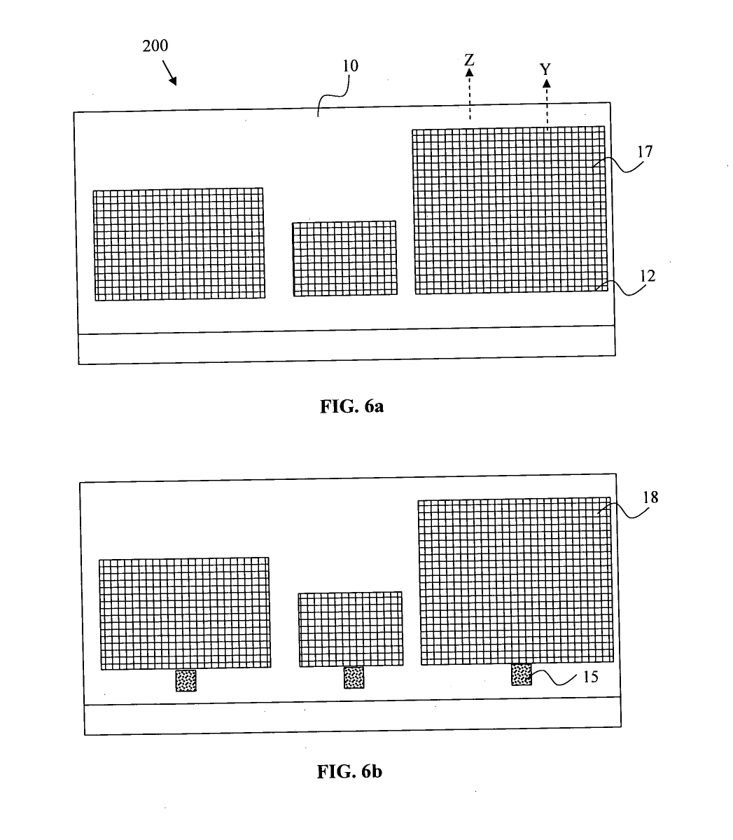

Reference is now made to FIG. 6a which schematically illustrates another embodiment of device 200. According to this embodiment, an array of plates 17 is pivotally connected to vertical support 10 via pivot 12, and cookers 20 are mechanically connected to plates 17 (not shown). According to this figure, a FOLDED position of device 200 is illustrated. In this position, plate 17 which is characterized by a plate plane Z, is substantially parallel to plane Y of vertical support 10. Device 200 has also an OPERATIVE position in which plate plane Z is perpendicular to plane Y of vertical support 10.

Reference is now made to FIG. 6a which schematically illustrates another embodiment of device 100.

According to this embodiment, each arm 15 is connected to each cooker (not shown) via a plate 18, such that each cooker is placed on plate 18.

According to some embodiments, device 100 can be made of metal, plastic, composites, alloys or any other material by any known in the art manufacturing, processing, coating or painting method.

According to some embodiments, device 100 can be operated by a mechanical, an electrical, an electronic or any other know in the art method of operation of a cooker.

According to some embodiments, device 100 can be automatic, semiautomatic, or non-automatic.

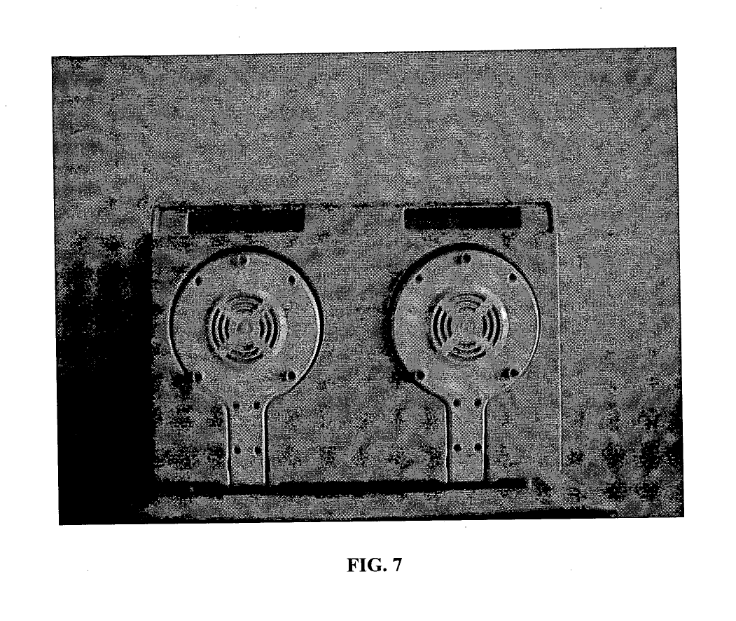

Reference is now made to FIG. 7 where illustrated a front view photograph of the device for food preparation according to a specific embodiment. In this embodiment the device comprises two arms with cookers connected to each arm. The device in this figure is in a FOLDED position.

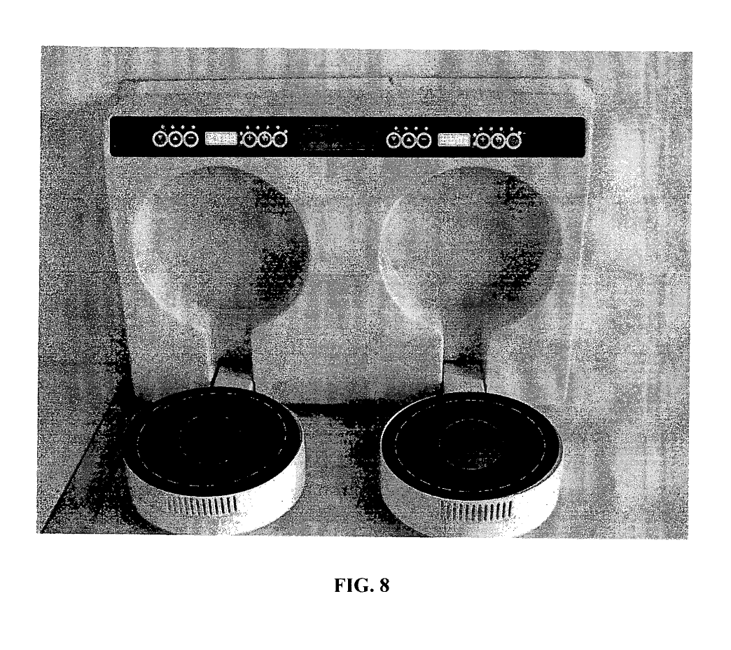

Reference is now made to FIG. 8 where illustrated a front view photograph of the device for food preparation according to a specific embodiment. In this embodiment the device comprises two arms with cookers connected to each arm. The device in this figure is in the OPERATIVE position, and the cookers are induction cookers.

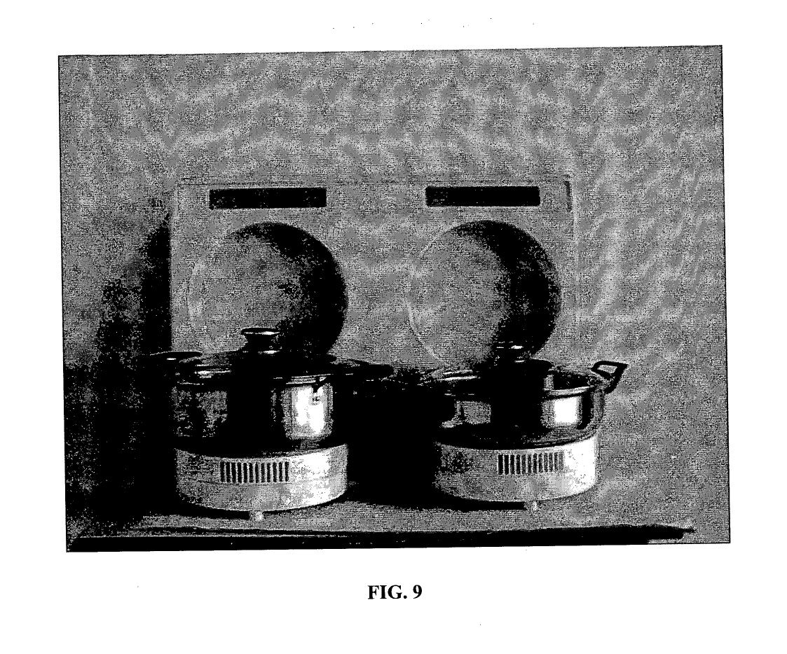

Reference is now made to FIG. 9 where illustrated a front view photograph of the device for food preparation according to a specific embodiment. In this embodiment the device comprises two arms with cookers connected to each arm. The device in this figure is in the OPERATIVE position. According to this figure, a pan is places on each of the cookers, and might be used for food preparation.

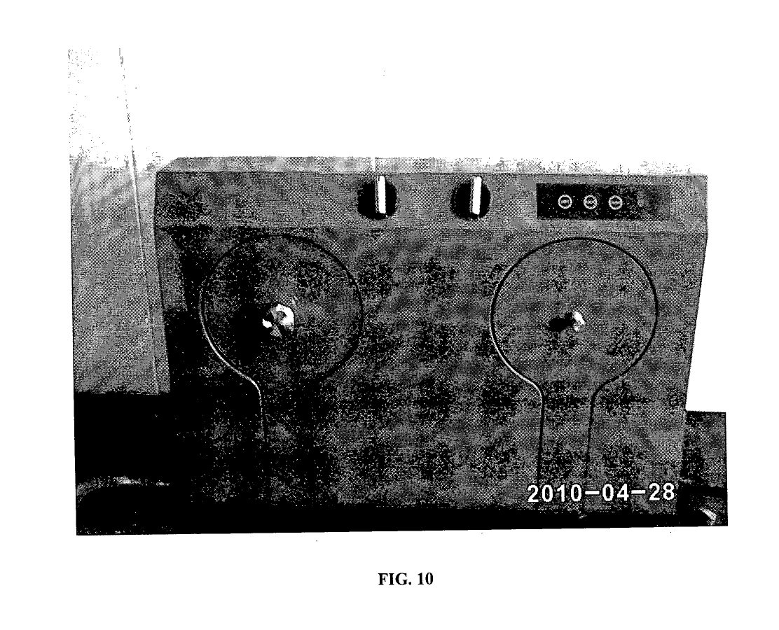

Reference is now made to FIG. 10 where illustrated a front view photograph of the device for food preparation according to a specific embodiment. In this embodiment the device comprises two arms with cookers connected to each arm. The device in this figure is in the FOLDED position, and the cookers are gas cookers.

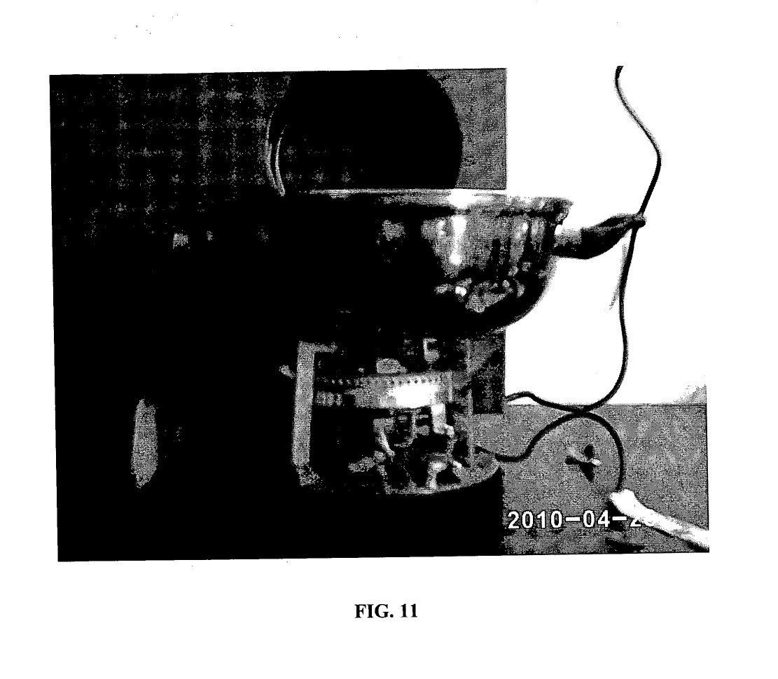

Reference is now made to FIG. 11 where illustrated a front view photograph of the device for food preparation according to a specific embodiment. In this embodiment the device comprises two arms with cookers connected to each arm. The device in this figure is in the OPERATIVE position, the cookers are gas cookers, and one of the cookers is provided with a pan on it.

1-46. (canceled)

47. A device for food preparation, said device comprising:
a. a vertical support;
b. at least one arm characterized by a longitudinal axis, said at least one arm being pivotally connected to said vertical support; and,
c. at least one cooker connected to at least one of said arms, such that said the plane of said at least one cooker is substantially parallel to said longitudinal axis of said at least one arm;
wherein said device being characterized by two positions: (i) a FOLDED position; and, (ii) a horizontally OPERATIVE position; in said FOLDED position, said longitudinal axis of said at least one arm is substantially parallel to said vertical support, and in said OPERATIVE position, said longitudinal axis of said at least one arm is substantially perpendicular to said vertical support; further wherein said device is adapted to save space when said device is in said FOLDED position.

48. The device of claim 47, wherein at least one of the following is being held true (a) said at least one cooker is selected from a group consisting of: a gas cooker, an electrical cooker, an electro-magnetic cooker, an induction cooker, an oil cooker, a solid fuel cooker, or any combination thereof; (b) said device is mountable to a wall by means of said vertical support; (c) said vertical support at least partially comprises the mechanism of said at least one cooker; (d) said device is characterized by an ability to hold a predetermined weight of a cooking container placed on said at least one cooker.

49. The device of claim 47, wherein said device further comprises an activation mechanism adapted to convert said device from said FOLDED position into said OPERATIVE position, and/or vice versa; wherein said activation mechanism is electronically activated by means of a switch.

50. The device of claim 47, wherein said device is adapted to be installed above a surface selected from a group consisting of: a table, a kitchen table, the kitchen working surface, the lower kitchen closet, the marble of the kitchen, or any combination thereof; wherein in OPERATIVE position, said at least one arm is in a lying position on said surface.

51. The device of claim 47, wherein said device further comprises at least one selected from (a) a gas supply with a gas valve adapted to be connected to said at least one cooker; (b) an electricity power supply for connecting said device to an electricity power source; and any combination thereof.

52. The device of claim 47, wherein said at least one arm is telescopic; wherein cooker is connected to said arm through a plate, such that said cooker is placed on said plate, and said plate is connected to said arm.

53. A method for using a device for food preparation, said method comprising steps of:
a. providing a device for food preparation, said device comprising: (i) a vertical support; (ii) an at least one arm characterized by a longitudinal axis, said at least one arm being pivotally connected to said vertical support; and, (iii) a at least one cooker connected to said at least one arm, such that said the plane of said at least one cooker is substantially parallel to said longitudinal axis of said at least one arm; said device being characterized by two positions: (i) a FOLDED position; and, (ii) a horizontally OPERATIVE position; in said FOLDED position, said longitudinal axis of said at least one arm is substantially parallel to said vertical support, and in said OPERATIVE position, said longitudinal axis of said at least one arm is substantially perpendicular to said vertical support;
b. converting said device into said OPERATIVE position by pulling and lowering said at least one cooker from said vertical support to the direction of the user of said device, and thereby causing said at least one cooker to be substantially perpendicular to said vertical support;
c. converting said device into said FOLDED position by pushing and lifting said at least one cooker from the direction of the user of said device to the direction of said vertical support, and thereby causing said at least one arm to be substantially parallel to said vertical support.
wherein said step of converting said device into said FOLDED position adapted to cause said device to save space.

54. The method for using a device of claim 53, further comprising at least one step selected from (a) selecting said at least one cooker from a group consisting of: a gas cooker, an electrical cooker, an electro-magnetic cooker, an induction cooker, an oil cooker, a solid fuel cooker, or any combination thereof; (b) mounting said device to a wall by means of said vertical support.

55. The method for using a device of claim 53, wherein at least one of said steps of converting said device into said OPERATIVE position and converting said device into said FOLDED position are performed via an activation mechanism.

56. The method for using a device of claim 53, further comprising steps of (a) selecting a surface above which selected device is installed from a group consisting of: a table, a kitchen table, the kitchen working surface, the lower kitchen closet, the marble of the kitchen, or any combination thereof; (b) lying said at least one arm on said surface.

57. The method for using a device of claim 53, further comprising steps of (a) placing a cooking container on said at least one cooker; (b) activating said at least one cooker, and thereby cooking the food contained in said cooking container; (c) holding a predetermined weight of said cooking container placed on said at least one cooker.

58. The method for using a device of claim 53, further comprising at least one step selected from (a) elongating the length of said at least one arm, wherein said at least one arm is telescopic; (b) placing said cooker on a plate and connecting said plate to said arm.

59. A device for food preparation, said device comprising:
a. a vertical support;
b. at least one plate with a plate plane, said at least one plate being pivotally connected to said vertical support; and,
c. at least one cooker seated upon said at least one plate, such that said the plane of said at least one cooker is substantially parallel to said plane of said at least one plate;
wherein said device being characterized by two positions: (i) a FOLDED position; and, (ii) a horizontally OPERATIVE position; in said FOLDED position, said plane of said at least one plate is substantially parallel to said vertical support, and in said OPERATIVE position, said plane of said at least one plate is substantially perpendicular to said vertical support; further wherein said device is adapted to save space when said device is in said FOLDED position.

60. The device of claim 59, wherein said at least one cooker is selected from a group consisting of: a gas cooker, an electrical cooker, an electro-magnetic cooker, an induction cooker, an oil cooker, a solid fuel cooker, or any combination thereof.

61. The device of claim 59, wherein said device is mountable to a wall by means of said vertical support.

62. The device of claim 59, wherein said device further comprises an activation mechanism adapted to convert said device from said FOLDED position into said OPERATIVE position, and/or vice versa; further wherein said activation mechanism is electronically activated by means of a switch.

63. The device of claim 59, wherein said device is adapted to be installed above a surface selected from a group consisting of: a table, a kitchen table, the kitchen working surface, the lower kitchen closet, the marble of the kitchen, or any combination thereof; further wherein in OPERATIVE position, said at least one plate is in a lying position on said surface.

64. The device of claim 59, wherein said vertical support at least partially comprises the mechanism of said at least one cooker.

65. The device of claim 59, wherein said device is characterized by an ability to hold a predetermined weight of a cooking container placed on said at least one cooker.

66. The device of claim 59, wherein said device further comprises at least one selected from (a) gas supply with a gas valve adapted to be connected to said at least one cooker; (b) electricity power supply for connecting said device to an electricity power source.

67. The device of claim 59, wherein said at least one arm is telescopic.

68. A method for using a device for food preparation, said method comprising steps of:
a. providing a device for food preparation, said device comprising: (i) a vertical support; (ii) at least one plate with a plate plane, said at least one plate being pivotally connected to said vertical support; and, (iii) at least one cooker seated upon said at least one plate, such that said longitudinal axis of said at least one arm is substantially parallel to said plane of said at least one plate; said device being characterized by two positions: (i) a FOLDED position; and, (ii) a horizontally OPERATIVE position; in said FOLDED position, said plane of said at least one plate is substantially parallel to said vertical support, and in said OPERATIVE position, said plane of said at least one plate is substantially perpendicular to said vertical support; further wherein said device is adapted to save space when said device is in said FOLDED position;
b. converting said device into said OPERATIVE position by pulling and lowering said at least one plate from said vertical support to the direction of the user of said device, and thereby causing said at least one plate to be substantially perpendicular to said vertical support;
c. converting said device into said FOLDED position by pushing and lifting said at least one plate from the direction of the user of said device to the direction of said vertical support, and thereby causing said at least one cooker to be substantially parallel to said vertical support.
wherein said step of converting said device into said FOLDED position adapted to cause said device to save space.

69. The method for using a device of claim 68, further comprising at least one step selected from (a) selecting said at least one cooker from a group consisting of: a gas cooker, an electrical cooker, an electro-magnetic cooker, an induction cooker, an oil cooker, a solid fuel cooker, or any combination thereof; (b) mounting said device to a wall by means of said vertical support; (c) selecting a surface above which selected device is installed from a group consisting of: a table, a kitchen table, the kitchen working surface, the lower kitchen closet, the marble of the kitchen, or any combination thereof; (d) lying said at least one arm on said surface.

70. The method for using a device of claim 68, wherein at least one of said steps of converting said device into said OPERATIVE position and converting said device into said FOLDED position are performed via activation mechanism.

71. The method for using a device of claim 68, further comprising steps of (a) placing a cooking container on said at least one cooker; (b) activating said at least one cooker, and thereby cooking the food contained in said cooking container; (c) holding a predetermined weight of said cooking container placed on said at least one cooker.

72. The method for using a device of claim 68, further comprising a step of elongating the length of said at least one arm, wherein said at least one arm is telescopic.
